(19) United States
(12) Patent Application Publication
(10) Pub. No.: US 2010/0143675 A1
(43) Pub. Date: Jun. 10, 2010

(54) INKS AND COATINGS FOR THE PRODUCTION OF OXYGEN SENSITIVE ELEMENTS WITH IMPROVED PHOTOSTABILITY

(76) Inventors: Adrian Guckian, Dunboyne (IE); Maja Dyson, Dunboyne (IE)

Correspondence Address: BROWN RUDNICK LLP, ONE FINANCIAL CENTER, BOSTON, MA, 02111, US

(21) Appl. No.: 12/515,708

(22) PCT Filed: Nov. 20, 2007
(86) PCT No.: PCT/IB07/04625

§ 371 Date: Feb. 18, 2010

Related U.S. Application Data
(60) Provisional application No. 60/860,164, filed on Nov. 20, 2006.
(60) Provisional application No. 60/897,084, filed on Jan. 24, 2007.
(60) Provisional application No. 60/898,510, filed on Jan. 31, 2007.
(60) Provisional application No. 60/903,939, filed on Feb. 28, 2007.
(60) Provisional application No. 60/904,105, filed on Mar. 1, 2007.

(51) Int. Cl. C09D 11/00; B32B 3/10; B32B 9/04; B32B 27/36; B32B 27/06; B32B 27/32; B32B 27/30; B32B 17/06; B32B 15/04; B32B 23/04; B32B 29/00; B32B 27/34

(52) U.S. Cl. 428/209; 106/31.13; 428/195.1; 428/411.1; 428/412; 428/480; 428/523; 428/522; 428/426; 428/457; 428/532; 428/537.5; 428/474.4; 428/210; 428/211.1; 524/611

(57) ABSTRACT

An oxygen sensitive ink or coating with enhanced photostability, comprising an oxygen sensitive indicator, a photostabilizer, an oxygen permeable binder and a solvent mixture is provided. The oxygen sensitive indicator is selected from, but not limited to [Ru(L1)(L2)(L3)]²⁺, wherein Ru represents the central ruthenium ion, L1, L2 and L3 represent the bidentate ligands diphenylphenanthroline, phenanthroline or bipyridine ligands or optionally substituted variations of same with representative counter ions selected from (PF6)-, Cl—, BF4-, Br— and (Cl04)-, platinum or palladium based metallo-porphyrin. The photostabilizer is selected from, but not limited to CIBA TINUVIN 5236, TINUVIN 292, TINUVIN 123 and TINUVIN 272, TINUVIN 477W, DABCO and ascorbic acid. Oxygen sensitive elements incorporating the oxygen sensitive ink or coating are manufactured by printing on a continuous flexible or rigid substrate using printing method including ink-jet, gravure, flexographic, pad printing or pin printing.

### CROSS-REFERENCE TO RELATED APPLICATIONS

This patent application claims priority to U.S. Provisional Patent Application No. 60/860,164, filed Nov. 20, 2006; U.S. Provisional Patent Application No. 60/897,084, filed Jan. 24, 2007; U.S. Provisional Patent Application No. 60/898,510, filed Jan. 31, 2007; U.S. Provisional Patent Application No. 60/904,105, filed Feb. 28, 2007 and U.S. Provisional Patent Application No. 60/903,939 filed Feb. 28, 2007, the entire contents of each are incorporated herein by reference.

### BACKGROUND

1. Technical Field

The present disclosure generally relates to printable oxygen sensitive elements (OSEs) with improved photostability, more particularly, to a method of producing oxygen sensitive inks and coatings which when printed or deposited produce OSEs that exhibit improved photostability.

2. Description of the Related Art

Modified Atmosphere Packaging (MAP) has been used since the mid 1950s and has steadily increased as a viable method of extending the shelf life of a wide variety of different products. Many industries incorporating MAP use materials that provide a barrier between the product and the external atmosphere as many of these products may become spoiled or degrade in the presence of oxygen. Products that require such packaging may include pharmaceuticals, food, medical devices or medical supplies. Due to the importance of the integrity of the packaging, it is imperative to detect any leaks in the packages to prevent spoilage or destruction of the product.

Generally, oxygen monitoring within packaging has required extensive testing and gas-sampling techniques. The standard method currently used to check the integrity of MAP involves the use of MAP analyzer instrument. This involves piercing the package using a needle probe to withdraw a sample of the protective gas atmosphere. The gas is then analyzed using an electrochemical sensor to determine the oxygen concentration. As this is a destructive method, only a small percentage of the packages can be tested and so 100% quality control is not possible. If a package is found to be leaking, what follows is a time consuming and costly process of back-checking and repacking. (e.g. PBI-Densor MAP Check Combi).

There are many visual indicators available for food packaging that are available in the form of inserts, however such inserts can lack accuracy.

In order to meet with the demands of the MAP industry an oxygen sensor has to be cheap, reproducible and easy to apply. U.S. Pat. No. 5,508,509 to Yafuso et al. has approached the issue by coating a continuous web with CO₂ sensing coatings doped with trisodium salt of hydroxypyrene trisulfonic acid (HIPS) and with O2 sensing coating doped with polynuclear aromatic, oxygen sensing compounds where the binder precursors were siloxane based.

Some have used cellulose acetate derivatives as matrices for oxygen sensing dyes. Ethyl cellulose, cellulose acetobutyrate and cellulose acetate are examples of cellulose derivatives and can provide good oxygen permeation which is crucial for oxygen sensing, with oxygen permeability constants [cm³ (STP)cm⁻² s cmHg×10⁻¹³] of 11, 3.56 and 5.85 respectively. Cellulosic resins are well known in the printing and coating industry.

Unfortunately, the oxygen sensitive indicator of many of these systems photobleaches, under illumination, even under ambient conditions, thereby reducing the usable, effective, lifetime of the sensitive element.

It is known that dye molecules fade under illumination, however, the rate of fading can vary greatly. Photo-bleaching refers to any photochemical transformation of a dye molecule which precludes their primary function, in our case their luminescence, which is used to measure the O₂ concentration via a fluorescence quenching mechanism. The photochemistry of ruthenium complexes in solution is dominated by ligand loss and replacement of one or more ligands by solvent molecules or counter ions.

It is believed photo-bleaching of many dyes affects only their emission intensities and not the decay time parameters (time constants, phase-shifts, or Stern-Volmer quenching constants), provided that photoproducts are non-emissive and there are no photo-induced changes in the dye's microenvironment (dye molecules and polymer's segments nearby). However, in addition to expected decrease of intensity upon illumination by light, some have observed that oxygen sensors made with ruthenium dyes also show a decrease of decay time parameters (e.g. phase shift) upon photo-bleaching. The conditions that can influence the photo-effects on decay-time parameters are: irradiance with light, presence of oxygen, type of polymer, high dye concentration and type of dye.

Use of anti-fading media for retardation of fluorescence fading in fluorescence microscopy has been used for several decades. Several mechanisms of physical and chemical scavenging of singlet oxygen can be very effective in protecting both the polymer matrix and the dye from photobleaching. Photostabilizers such as 1-4-diazabicyclo(2,2,2)-octane (DABCO) are used to slow down the degradation of fluorescence (photo-bleaching) due to continuous exposure to a light source in correlative microscopy. In plastics and in the ink-jet industry photostabilizers are used to slow down the photo-degradation of polymers and to stabilize the colorant dye. They can be divided into hindered amine light stabilizers (HALS) that act by scavenging the radical intermediates formed in the photo-oxidation process and UV absorbers (UVAs) that act by shielding the polymer from ultraviolet light. For example, U.S. Pat. No. 7,063,418 to Sen et al. used monomeric and oligomeric additives (HALS and UVAs) to stabilize dyes in porous ink-jet media.

### SUMMARY

Therefore, the present disclosure utilizes various approaches to reduce the photobleaching effect of light ruthenium based OSEs. Accordingly, it is desirable to provide printed OSEs and an oxygen measurement system that is cost effective and that can be used without breaching the seal integrity of the package. It is also desirable to provide this with increased photostability. Thus, the present disclosure relates to methodologies for the manufacture of oxygen sensitive inks, coatings and sensor elements and oxygen sensitive inks with improved photostability. Further, the non-invasive use of an oxygen sensor system to detect and measure concentrations of oxygen in gases in enclosed spaces, particularly gases enclosed in modified atmosphere packages containing such items as food, cosmetics, medical devices and pharmaceuticals is disclosed. Accordingly, the present disclosure proposes the use of the printed or coated packaging material or a printed or coated layer of the packaging material itself as the sensing element. Methodologies for the manufacture of these oxygen sensitive inks, coatings and OSEs with improved photostability are disclosed.

It was found that the addition of photostabilizers with the oxygen sensitive indicator significantly reduced the detrimental effect that light has on the performance of the oxygen sensitive coating or film and materially extended the stable life time of the OSEs. Depending on the deposition method, the formulation and the application, the use of photostabilizers has been found to extend the stable life time by anything from 200% to 1000%. Accordingly, the use of an optical oxygen sensor system utilizing OSEs with improved photostability to detect and measure non-invasively concentrations of oxygen in gases in enclosed spaces, particularly gases enclosed in modified atmosphere packaged packages, containing items including but not limited to gases, food, cosmetics, medical devices and pharmaceuticals is disclosed.

The oxygen sensitive ink or coating with enhanced photostability according to the present disclosure comprises an oxygen sensitive indicator, a photostabilizer, an oxygen permeable binder and a solvent mixture. The oxygen sensitive indicator is selected from, but not limited to [Ru(L1)(L2)(L3)]²⁺, wherein Ru represents the central ruthenium ion, L1, L2 and L3 represent the bidentate ligands diphenylphenanthroline, phenanthroline or bipyridine ligands or optionally substituted variations of same with representative counter ions selected from (PF6)-, Cl—, BF4-, Br— and (Cl04)-, platinum or palladium based metallo-porphyrin. The photostabilizer may be selected from, but not limited to CIBA TINUVIN 5236, TINUVIN 292, TINUVIN 123 and TINUVIN 272, TINUVIN 477W, DABCO and ascorbic acid. Additionally, the binder may be selected from but not limited to the cellulosic resins family. The solvent mixture is either alcohol:ester or alcohol:ketone, or any other combinations thereof.

Oxygen sensitive elements incorporating the oxygen sensitive ink or coating can be manufactured by printing on a continuous flexible or rigid substrate. A variety of printing methods may be used including ink-jet, gravure, flexographic, pad printing, pin printing. Additionally, the oxygen sensitive elements incorporating the oxygen sensitive ink or coating may be manufactured by coating a continuous flexible or rigid substrate. A variety of methods to coat the substrate may be used and include knife coating, air coating, roll coating, rod coating, gravure coating. The flexible and rigid substrates of include, but are not limited to PET, PP, PE, PC, PMMA, glass, metal sheets, cellulose acetate, polyamide, paper and metallised plastic film.

### BRIEF DESCRIPTION OF THE DRAWINGS

The objects and features of the present disclosure are set forth with particularity in the appended claims. The present disclosure, as to its organization and manner of operation, together with further objectives and advantages may be understood by reference to the following description, taken in connection with the accompanying drawings, in which:

FIG. 1 is a chart showing the phase shift used for calculating concentration of oxygen in accordance with the present disclosure;

FIG. 2 depicts interrogation of a possible structure incorporating the printed or coated oxygen sensor in accordance with the present disclosure;

FIG. 3 depicts detection of irradiated light from a possible structure incorporating the printed or coated oxygen sensor in accordance with the present disclosure;

FIG. 4 graphs the changes in the signal to reference values recorded for non photo-stabilized, ink-jet printed OSEs on exposure to ambient light;

FIG. 5 is a graph showing the changes in the signal to reference values recorded for non photo-stabilized, ink jet printed OSEs on exposure to light from an accelerated aging light source;

FIG. 6 is a graph showing the changes in the signal to reference values recorded for photostabilized, ink-jet printed OSEs on exposure to ambient light; and

FIG. 7 is a graph showing the changes in the signal to reference values recorded for photostabilized, ink-jet printed OSEs on exposure to light from an accelerated aging light source.

### DETAILED DESCRIPTION OF EXEMPLARY EMBODIMENTS

The present disclosure relates to the manufacture of oxygen sensitive inks and coatings with enhanced photo-stability and OSEs incorporating such oxygen sensitive inks and coatings. Oxygen sensitive inks are, made for example, by immobilizing ruthenium complex based dyes directly into an oxygen permeable binder which can then be deposited reel to reel as oxygen sensitive printed patterns, oxygen sensitive coatings on a substrate film and subsequently be laminated into an oxygen sensitive laminate construction.

It is contemplated that the oxygen sensitive inks and coatings and OSEs made thereof may be used for a variety of different applications. The oxygen sensitive printed inks and coatings with improved photo-stability according to the present disclosure may be used to non-invasively detect and measure concentrations of oxygen in enclosed spaces, including gases enclosed in MAP packages containing items including, but not limited to liquids, gases, food, cosmetics, medical devices and pharmaceuticals.

The manufacture of the oxygen sensitive inks and coatings occur through the mixing of polymer binder with solvent and subsequent addition of oxygen sensitive chemical compound (indicator). At least one photostabilizer was added at the point of introduction of the oxygen sensitive chemical compound (indicator). Polymeric materials used as binders in oxygen sensitive inks and coatings can be cellulosic resins such as cellulose acetate, ethyl cellulose and cellulose acetate esters.

Oxygen sensitive chemical compounds or indicators that may be used in according with the present disclosure include, but are not limited to [Ru(L1)(L2)(L3)]²⁺, wherein Ru represents a central ruthenium atom, L1, L2 and L3 represent the bidentate ligands diphenylphenanthroline, phenanthroline or bipyridine ligands or optionally substituted variations of same with representative counter ions including but not limited to (PF6)-, Cl—, BF4-, Br— and (Cl04)-, and platinum or palladium based metallo-porphyrins. The amount of the oxygen sensitive compound can vary anywhere between 0.1-10% wt of the polymer binder. A number of compounds may be added to improve the photostability of the oxygen sensitive indicator in the polymer matrix.

In order to extend the workable shelf life of OSEs, a photostabilizer may be added at the point of introduction of the oxygen sensitive compound. These photostabilizers (hindered amines) work for example, by the quenching of singlet oxygen by amines which is assumed to proceed via formation of an intermediate partial charge transfer complex, due to the lone electron pair of the amine. In order for the photostabilizers to work efficiently, they have to be used in the correct ratio. Depending on the application, ratio can be varied between 1% and 10% of photostabilizer to the amount of the oxygen sensitive indicator in the ink/coating. Examples of suitable photostabilizers include, but are not limited to TINUVIN 123, TINUVIN 292, TINUVIN 5236 and TINUVIN 477DW.

The solvents used for the preparation of the ink are mixtures of alcohols and esters/ketones. Suitable alcohols include, but are not limited to, methanol, ethanol, isopropanol, and suitable esters/ketones such as ethyl acetate, acetone and methyl ethyl ketone. The volume ratios between alcohol and ester/ketones can vary from approximately 1:1 to 1:5.

Oxygen sensitive inks and coatings can be deposited onto flexible and rigid substrates using printing methods such as inkjet, pin, pad, gravure, flexographic printing and coating methods such as air, knife, rod, roll, gravure and curtain coating. The substrates used in reel to reel printing include, but are not limited to, PET, PP, PE, PC, cellulose acetate, polyamide, paper and metallised plastic film, glass, PMMA and metal sheets.

These coated substrates can be used in conjunction with other materials such as lamination adhesive, barrier layers, reflective layers and scavenger materials layers to form the final laminate structure. Lamination adhesives, for example, may be two component, solvent borne adhesives based on polyurethane; two component water dispersed urethane adhesive, acrylic based lamination adhesives (waterborne and solventborne), or styrene butadiene co-polymer based adhesives.

Short term application barrier material that may be used in accordance with the present disclosure include, but are not limited to polyethylene terephthalate sold under the trade name Mylar©, polyvinylidene chloride sold under the trade name Saran©, or oriented nylon. For long-term applications, transparent films based on vacuum deposited ceramics, Escal™ and PTS films by Mitsubishi Gas Chemical; fluoropolymers such as Chlorortrifluoroethylene sold under the trade name Aclar© or ethylene vinyl alcohols (EVOH) can be used as barrier materials.

Once the oxygen sensitive ink or coating is printed or coated into a desired end product, it may be used in an OSE. The concentration of oxygen can be non-invasively measured within an enclosed atmosphere, such as that within a sealed package, bottle or vial by interrogation of the OSE with an excitation beam and subsequent analysis of the irradiated light. The generation of the excitation beam, collection of the irradiated beam and subsequent analysis yields the oxygen concentration and may be accomplished using a single opto-electronic mobile hand held analyzer.

The OSE as described above may consist of an oxygen-sensitive luminophore such as [RUII-Tris(4,7-diphenyl-1,10-phenanthroline)]2+, referred to as [Ru(dpp)3]2+, as previously described, immobilised in an oxygen-permeable polymeric binder. Upon illumination or excitation of the luminophore by light of a suitable wavelength, the complex absorbs photons of light and an electron is within the complex is excited to a higher energy level. The excited-state lifetime refers to the average time the luminophore remains in this excited state. Naturally, the luminophore returns to its ground state with the emission of a photon of light.

Should the emitted photon of light from the luminophore collide with an oxygen molecule, the photon looses its energy through formation of an exciplex. In this instance, the luminophore returns to ground state without the emission of a photon and so the observed luminescence is effectively quenched. Since the extent of quenching is proportional to the quantity of oxygen molecules present this process can be exploited as a sensing mechanism. Essentially, measuring the duration of the excited-state lifetime measures the oxygen concentration.

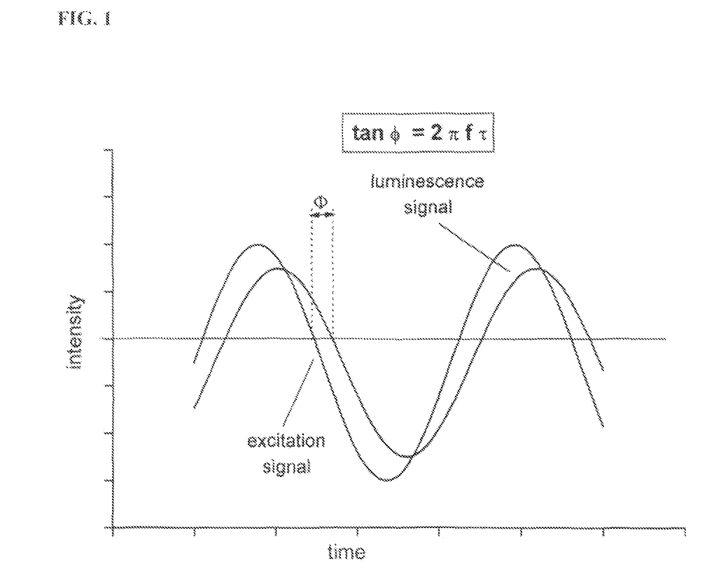

This phenomenon is exploited by using the excited-state lifetime which we measure via phase fluorometry. This phenomenon is shown in FIG. 1. If the excitation signal 10 is sinusoidally modulated, the luminophore's luminescence 12 is also modulated but is time delayed or phase shifted relative to the excitation signal. The relationship between the excited-state lifetime, π, and the corresponding phase shift, φ, for a single exponential decay is:

$$τ = \frac{tan φ}{2 π f}$$

where, f is the modulation frequency. This phase shift is illustrated in FIG. 1.

Electronics used may be, for example, a blue light emitting diode (LED), such as that provided by Nichia under catalog number NSPB500S, as the excitation source. The detector may be a silicon photodiode such as that provided by Hammamatsu™ under catalog number S1223-01. The phase shift is recovered from the optical signal via a phase-lock loop circuit. The optoelectronic and electronic components may be housed in a device such as the GSS 450 Oxygen Analyser™.

The continuous web of a substrate printed or coated with oxygen sensitive ink or coating may be incorporated within a multi-layered laminate packaging film or material to non-invasively measure the concentration of oxygen within an enclosed atmosphere such as that within a sealed environment. The laminate material can act simultaneously as both an oxygen sensor for the enclosed atmosphere and as an oxygen barrier to restrict the movement of oxygen from outside the package inwards and vice versa.

Multiple laminate layers can be formed by reel-to-reel lamination of each layer in such a way that lamination adhesive is applied on the polymeric film, barrier film and/or reflective layer film. Lamination adhesive can be applied using roll, knife, and rod coating.

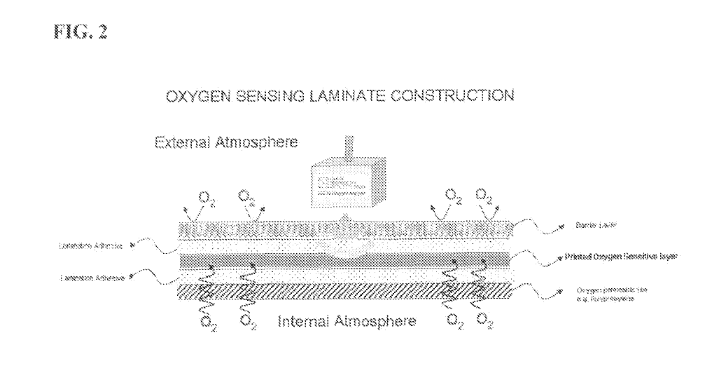

FIG. 2 shows the interrogation of the printed oxygen sensitive layer by the blue LED from an optical head. The optical head such as the GSS 450 Oxygen Analyser™ includes the electronics for interrogation and detection of subsequent emitted light. The laminate structure shown in FIG. 2 includes a barrier layer, a layer of a substrate printed or coated with oxygen sensitive ink/coating according to the present disclosure, a layer of oxygen permeable film such as polypropylene and two lamination layers. The optical head includes a blue LED which interrogates the oxygen sensitive plastic layer as shown by.

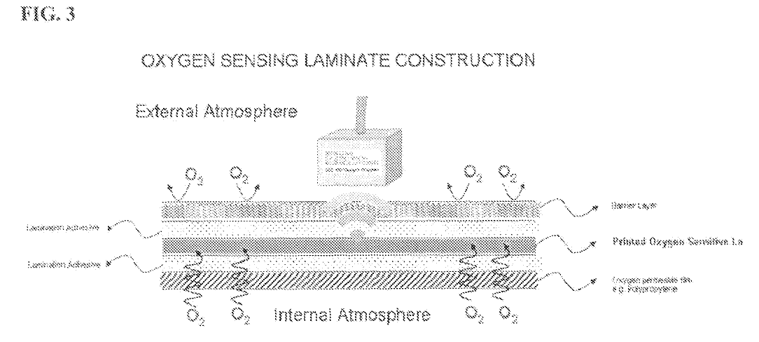

FIG. 3 shows the subsequent analysis of the irradiated orange light from the irradiation of the printed oxygen sensitive layer according to the present disclosure. This irradiated orange light is subsequently detected by the optical head which includes a detector. Oxygen concentration is then determined.

### EXAMPLES

### Example 1

### Preparation of Non Photostabilized Ink-Jet Ink

150 mL of Ethyl Acetate is mixed with 40 mL of isopropanol. 8 g of cellulose acetate butyrate Mr 12,000 is added. The mixture is thoroughly stirred. 0.4 g of Ru-tris(4,7-diphenyl-1,10-phenanthroline) dichloride added to 40 mL of isopropanol. The mixture is stirred until all the Ru-tris(4,7-diphenyl-1,10-phenanthroline) dichloride is fully dissolved. This solution is then added into the polymer solution and stirred for additional 20 min.

### Example 2

### Preparation of Non Photostabilized Gravure Ink

Low viscosity coating solution: 150 mL of Ethyl Acetate is mixed with 50 mL of isopropanol. 11 g of cellulose acetate butyrate Mr 32,000 is added. The mixture is thoroughly stirred. 0.5 g of Ru-tris(4,7-diphenyl-1,10-phenanthroline) dichloride is added to 40 mL of isopropanol. The mixture is stirred until all the Ru-tris(4,7-diphenyl-1,10-phenanthroline) dichloride is fully dissolved. This solution is then added into the polymer solution and stirred for additional 20 min.

Higher viscosity printing ink: 165 mL of Ethyl Acetate is mixed with 30 mL of isopropanol. 18 g of cellulose acetate butyrate Mr 32,000 is added. The mixture is thoroughly stirred, 0.6 g of Ru-tris(4,7-diphenyl-1,10-phenanthroline) dichloride is added to 30 mL of isopropanol. The mixture is stirred until all the Ru-tris(4,7-diphenyl-1,10-phenanthroline) dichloride is fully dissolved. This solution is then added into the polymer solution and stirred for additional 20 min.

### Example 3

### Preparation of Ink-Jet Ink with Photo-Stabilizer

150 mL of Ethyl Acetate is mixed with 50 mL of isopropanol. 8 g of cellulose acetate propyonate Mr 16,000 is added. The mixture is thoroughly stirred. 0.4 g of Ru-tris(4,7-diphenyl-1,10-phenanthroline) dichloride and 0.02 g of TINUVIN 477W is added to 40 mL of isopropanol. The mixture is stirred until all the Ru-tris(4,7-diphenyl-1,10-phenanthroline) dichloride is fully dissolved. This solution is then added into the polymer solution and stirred for additional 20 min.

### Example 4

### Preparation of the Ink for Gravure Coating with Photo-Stabilizer

Low viscosity coating solution: 150 mL of Ethyl Acetate is mixed with 50 mL of isopropanol. 11 g of cellulose acetate butyrate Mr 32,000 is added. The mixture is thoroughly stirred. 0.5 g of Ru-tris(4,7-diphenyl-1,10-phenanthroline) dichloride and 0.03 g of TINUVIN 5236 are added to 40 mL of isopropanol. The mixture is stirred until all the Ru-tris(4,7-diphenyl-1,10-phenanthroline) dichloride is fully dissolved. This solution is then added into the polymer solution and stirred for additional 20 min.

Higher viscosity printing ink: 165 mL of Ethyl Acetate is mixed with 30 mL of isopropanol. 18 g of cellulose acetate butyrate Mr 32,000 is added. The mixture is thoroughly stirred. 0.6 g of Ru-tris(4,7-diphenyl-1,10-phenanthroline) dichloride and 0.036 g of TINUVIN 5236 are added to 30 mL of isopropanol. The mixture is stirred until all the Ru-tris(4,7-diphenyl-1,10-phenanthroline) dichloride is fully dissolved. This solution is then added into the polymer solution and stirred for additional 20 min.

### Example 5

### Ink Jet Printing

All the ink-jet printed samples were deposited using a Domino MacroJet printer. The ink viscosity in Shell cup #1 was between 19 and 23 depending on the polymer material used. Samples were printed on line at speed of 6 m/min, and ran through a fan oven at 50° C.

### Example 6

### Gravure Coating and Printing

All the gravure coated samples were coated using RK Print Gravure Coater. The overall coating was obtained using 100 QCH anilox cylinder and the ink viscosity with Zahn Cup #1 was 26 seconds. The RK Print Gravure Coater was run at the speed of 10 m/min and the temperature of fans was 50° C. The pressure in the rewinder was 20 psi and in the coater head the pressure was 30 psi.

For the patterned, gravure printed samples the same RK Print Gravure Coater was used. The gravure patterned cylinder had cells 160 micron deep with a volume of 15 BCM. The ink viscosity required for printing was in Zahn cup #2 15 seconds. The RK Print Gravure Coater was run at a speed of 10 m/min and the temperature of fans was 50° C. The pressure in the rewinder was 20 psi and in the coater head the pressure was 30 psi.

### Studies and Results

The photostability of the OSEs in question were studied using a GSS 450 Oxygen Analyser™. This equipment consisted of two channels, a reference channel and a signal channel. The two channels consisted of identical components. The reference channel was used to compensate for any temperature changes that the electronic unit is subjected to. The phase angle of the signal channel was the measured phase difference between the sinusoidally modulated excitation signal and the resultant fluorescent signal which is phase shifted with respected to the excitation signal and is dependent on oxygen concentration. The phase angle of the reference channel is the measured phase difference between the sinusoidally modulated excitation signal and the resultant fluorescent signal from the LED which is phase shifted with respected to the excitation signal and is dependent on temperature. The phase signals (signal and reference) were fed into a phase detector and processed. A control experiment was carried out to demonstrate that the changes in the signal to reference values observed in the following experiments are due to photobleaching, induced by illumination of the OSEs. The results of the control experiment are presented in Table 1. A non photo-stabilised OSE when stored in the dark over the same 600 minutes period of the experiment exhibited no change in the signal to reference value recorded with the GSS 450 Oxygen Analyser™.

TABLE 1
Change in signal to reference value when
non-photostabilized OSE is stored in the dark.

| Time | Change in signal |
|---|---|
| in the | to reference |
| dark/min | values (a.u.) |
| 0 | — |
| 10 | 0.0 |
| 20 | 0.0 |
| 30 | 0.0 |
| 40 | 0.0 |
| 50 | 0.0 |
| 60 | 0.0 |
| 120 | 0.0 |
| 180 | 0.0 |
| 240 | 0.0 |
| 300 | 0.0 |
| 360 | 0.0 |
| 420 | 0.0 |
| 480 | 0.0 |
| 540 | 0.0 |
| 600 | 0.0 |

### Experiment A) Sensitivity of Non Photo-Stabilised Ink-Jet Printed OSEs to Ambient Light

Samples of the ink-jet printed materials from Example 1 to be tested were cut into 2 cm×2 cm squares and placed into a flow cell. The flow cell was then flushed with 100% N₂. Once the gases within the flow cell had equilibrated at 100% N₂, a signal to reference value reading was taken with the GSS 450 Oxygen Analyser™.

The samples were then removed from the flow cell and exposed to constant ambient light in order to investigate the photodegradation of the dye. The power of the ambient light source was measured using a Solar Light Testing—dose control system to be 1 W/m².

The samples were exposed to the ambient light source for varying amounts of time. The effect of the varying doses on the readings were tracked by replacing the samples into the flow-cell and taking measurements under nitrogen with the GSS 450 Oxygen Analyser™ at periodic intervals. Table 2 below tracks the changes in the signal to reference of a sensor which has been exposed to light for varying amounts of time.

TABLE 2
Changes in signal to reference values for
a non photo-stabilised ink jet printed sensor
on exposure to constant light at 1 W/m2.

| Time of | Change |
|---|---|
| exposure to | in Signal |
| the ambient | to reference |
| light/min | values (a.u.) |
| 0 | — |
| 10 | −0.3 |
| 20 | −0.6 |
| 30 | −1 |
| 40 | −1.3 |
| 50 | −1.5 |
| 60 | −2.2 |
| 120 | −3.3 |
| 180 | −4.8 |
| 240 | −5.8 |
| 300 | −6.9 |
| 360 | −8 |
| 420 | −8.5 |
| 480 | −9.9 |
| 540 | −10.5 |
| 600 | −11.2 |

Table 2 shows recorded changes in signal to reference value for OSEs without photostabilizer made in accordance with the methodology of example 1 due to varying exposures to light. Table 2 shows that the exposure to light causes a decrease in the signal to reference values of the exposed OSE, inferring that the emissive dye molecule was being photobleached, which in turn was leading to a reduction in the oxygen concentration value being recorded by the GSS 450 Oxygen Analyser™. This reduction causes an error in the recorded value, as the changes are not due to changes in the gaseous atmosphere (all measurements were made at 100% N2), rather the changes are due to a photobleaching effect caused by the exposure of the sensors to the ambient light source.

### Experiment B) Sensitivity of Non Photo-Stabilised Ink-Jet Printed OSEs to an Accelerated Aging Light Source

The experimental conditions were the same as in Experiment A, with the exception of the light source, which was an accelerated aging light source (33 W/m²; measured by Solar Light Testing—dose control system). The accelerated aging light source was used to simulate accelerated photobleaching conditions.

TABLE 3
Changes in signal to reference values for
a non photo-stabilised ink jet printed sensor
on exposure to constant light at 33 W/m2.

| Time of | Change |
|---|---|
| exposure to the | in Signal |
| accelerated aging | to reference |
| source/min | values (a.u.) |
| 0 | — |
| 10 | −1.8 |
| 20 | −3.8 |
| 30 | −5.8 |
| 40 | −7.5 |
| 50 | −8.1 |
| 60 | −9.7 |
| 120 | −15.5 |
| 180 | −20.1 |
| 240 | −24.1 |
| 300 | −25.8 |
| 360 | −29.4 |
| 420 | −31.6 |
| 480 | −32.4 |

Table 3 shows recorded changes in signal to reference value for OSEs without photostabilizer made in accordance with the methodology of example 1 due to varying exposures to an accelerated aging light source. Table 3 shows that the exposure to this light causes a decrease in the signal to reference values of the exposed OSE, inferring that the emissive dye molecule was being photobleached, which in turn was leading to a reduction in the oxygen concentration value being recorded by the GSS 450 Oxygen Analyser™ This reduction causes an error in the recorded value, as the changes are not due to changes in the atmosphere (all measurements were made at 100% N2), rather the changes are due to a photobleaching effect caused by the exposure of the sensors to the accelerated aging light source.

### Experiment C) Sensitivity of the Photo-Stabilised Ink-Jet Printed OSEs to an Ambient Light Source

Again, the photostability of the OSEs in question was studied using a GSS 450 Oxygen Analyser™. Samples of the ink-jet printed sensor materials made in accordance with example 3 to be tested were cut into 2 cm×2 cm squares and placed into a flow cell. The flow cell was then flushed with 100% N₂. Once the gases within the flow cell had equilibrated at 100% N₂ a reading was taken with the GSS 450 Oxygen Analyser™. The signal to reference value was recorded at 0% O2.

The samples were then removed from the flow cell and exposed to a constant ambient light source in order to investigate the effect of light on the photodegradation of the dye. Again, the power of the ambient light was measured using a Solar Light Testing—dose control system to be 1 W/m².

The samples were exposed to the ambient light source for varying amounts of time. The effect of the varying doses on the readings was tracked using the flow-cell and GSS 450 Oxygen Analyser. Table 4 below tracks the changes in the signal to reference values.

TABLE 4
Changes in signal to reference values for
a photo-stabilised ink jet printed sensor on
exposure to constant light at 1 W/m2.

| Time of | Change in |
|---|---|
| exposure to | Signal to |
| the ambient | reference |
| light/min | values (a.u.) |
| 0 | — |
| 10 | −0.1 |
| 20 | −0.1 |
| 30 | −0.1 |
| 40 | −0.2 |
| 50 | −0.2 |
| 60 | −0.3 |
| 120 | −0.3 |
| 180 | −0.3 |
| 240 | −0.3 |
| 300 | −0.4 |
| 360 | −0.5 |
| 420 | −0.8 |
| 480 | −0.8 |
| 540 | −0.8 |
| 600 | −1.1 |

Table 4 shows the recorded changes in the signal to reference values recorded for the OSEs containing photostabilizer due to varying exposure to a constant ambient light source. As with the results in Table 2, the samples showed photodegradation features. However, the rate of degradation is much slower in this instance, most notably at longer exposure times, where the rate of photodegradation was over 10 times slower than in case of OSE without photostabilizer.

### Experiment D) Sensitivity of a Photo-Stabilised Ink-Jet Printed OSEs to an Accelerated Aging Light Source

Same methodology and same exposure times were used in this case as in Experiment C, except the light source was an accelerated aging source (33 W/m²; measured by Solar Light Testing—dose control system). The accelerated aging light source was used to simulate accelerated photo-bleaching conditions.

TABLE 5
Changes in signal to reference values for
a photo-stabilised ink jet printed sensor on
exposure to constant light at 33 W/m2.

| Time of | Change in |
|---|---|
| exposure to | Signal to |
| the strong light | reference |
| source/min | values (a.u.) |
| 0 | — |
| 10 | −0.5 |
| 20 | −0.7 |
| 30 | −0.9 |
| 40 | −1.1 |
| 50 | −1.4 |
| 60 | −2.6 |
| 120 | −3.4 |
| 180 | −4.2 |
| 240 | −4.9 |
| 300 | −5.4 |
| 360 | −6 |
| 420 | −6.7 |
| 480 | −7.1 |

Table 5 shows recorded changes in the signal to reference values recorded for the OSEs containing photostabilizer due to varying exposure to an accelerated aging light source. As with the results in Table 3, the samples showed photodegradation features. However, the rate of degradation is much slower in this instance, most notably at longer exposure times, where the rate of photodegradation was over 5 times slower than in the case of the non photo-stabilised ink-jet printed OSE.

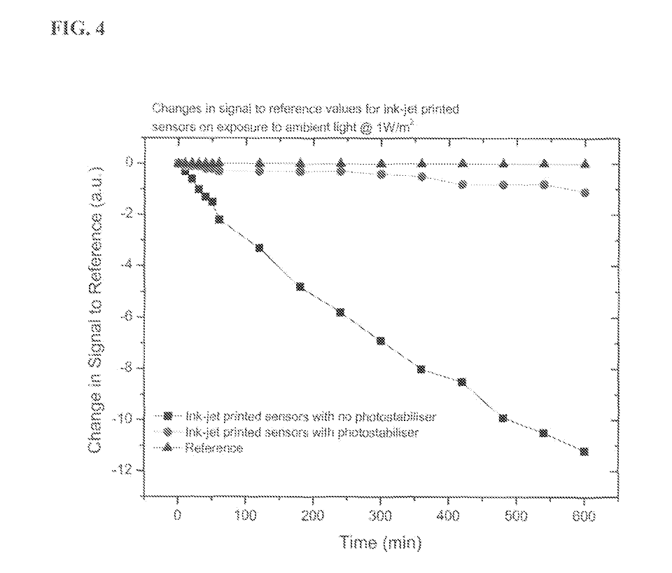

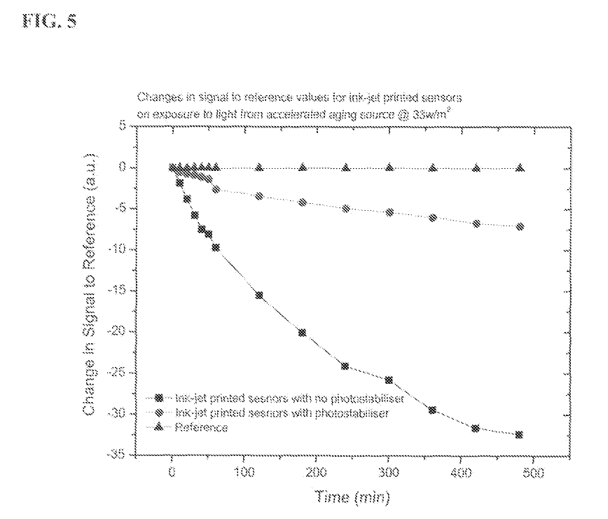

FIG. 4 (ambient light) and FIG. 5 (accelerated aging light) compare changes in the signal to reference values recorded for an OSE stored in the dark, that with no photostabilizer and one with photostabilizer. These results point to the effectiveness of adding photostabilizers to the oxygen sensitive inks and coatings in order to improve the long term photostability of the finished OSE. This experiment highlights a 10-fold reduction in the loss of signal over time for the OSE containing photostabilizer versus the OSE without photostabilizer under ambient light conditions and a 5-fold improvement in the case under accelerated aging conditions.

### Experiment E) Sensitivity of Non Photo-Stabilised Gravure Printed OSEs to Ambient Light

Samples of the gravure printed materials from Example 2 to be tested were cut into 2 cm×2 cm squares and placed into a flow cell. The flow cell was then flushed with 100% N₂. Once the gases within the flow cell had equilibrated at 100% N₂, a signal to reference value reading was taken with the GSS 450 Oxygen Analyser™.

The samples were then removed from the flow cell and exposed to ambient light source in order to investigate the photodegradation of the dye. The power of the ambient light source was measured using a Solar Light Testing—dose control system to be 1 W/m².

The samples were exposed to the ambient light source for varying amounts of time. The effect of the varying doses on the readings were tracked by replacing the samples into the flow-cell and taking measurements under nitrogen with the GSS 450 Oxygen Analyser™ at periodic intervals. Table 6 below tracks the changes in the signal to reference of a sensor which has been exposed to light for varying amounts of time.

TABLE 6
Changes in signal to reference values for
a non photo-stabilised gravure printed sensor
on exposure to constant light at 1 W/m2.

| Time of | Change in |
|---|---|
| exposure to | Signal to |
| the ambient | reference |
| light/min | values (a.u.) |
| 0 | — |
| 10 | −0.1 |
| 20 | −0.2 |
| 30 | −0.2 |
| 40 | −0.4 |
| 50 | −0.5 |
| 60 | −0.5 |
| 120 | −0.7 |
| 180 | −1.1 |
| 240 | −1.4 |
| 300 | −1.7 |
| 360 | −2 |
| 420 | −2.2 |
| 480 | −2.6 |
| 540 | −2.9 |
| 600 | −3 |

Table 6 shows recorded changes in signal to reference value for gravure printed OSEs without photostabilizer made in accordance with the methodology of example [2] due to varying exposures to constant ambient light. Table 6 shows that the exposure to light causes a decrease in the signal to reference values of the exposed OSE, inferring that the emissive dye molecule was being photobleached, which is turn was leading to a reduction in the oxygen concentration value being recorded by the GSS 450 Oxygen Analyser™. This reduction causes an error in the recorded value, as the changes are not due to changes in the atmosphere (all measurements were made at 100% N2), rather the changes are due to a photobleaching effect caused by the exposure of the sensors to the ambient light source.

### Experiment F) Sensitivity of Non Photo-Stabilised Gravure Printed OSEs to an Accelerated Aging Light Source

The same methodology and same exposure times were used as in Experiment E, with the exception of the light source which was an accelerated aging light source (33 W/m²; measured by Solar Light Testing—dose control system). The accelerated aging light source was used to simulate accelerated photo-bleaching conditions.

TABLE 7
Changes in signal to reference values for
a non photo-stabilized gravure printed sensor
on exposure to constant light at 33 W/m2.

| Time of | Change in |
|---|---|
| exposure to the | Signal to |
| accelerated aging | reference |
| source/min | values (a.u.) |
| 0 | — |
| 10 | −0.8 |
| 20 | −1.5 |
| 30 | −2 |
| 40 | −2.6 |
| 50 | −3 |
| 60 | −3.5 |
| 120 | −5.5 |
| 180 | −7.2 |
| 240 | −8.6 |
| 300 | −9.6 |
| 360 | −10.7 |
| 420 | −11.6 |
| 480 | −12.5 |
| 540 | −13.1 |
| 600 | −14.1 |

Table 7 shows recorded changes in signal to reference value for OSEs without photostabilizer made in accordance with the methodology of example [2] due to varying exposures to light. Table 7 shows that the exposure to light causes a decrease in the signal to reference values of the exposed OSE, inferring that the emissive dye molecule was being photobleached, which is turn was leading to a reduction in the oxygen concentration value being recorded by the GSS 450 Oxygen Analyser™. This reduction causes an error in the recorded value, as the changes are not due to changes in the atmosphere (all measurements were made at 100% N2), rather the changes are due to a photobleaching effect caused by the exposure of the OSEs to the accelerated aging light source.

### Experiment G) Sensitivity of Photo-Stabilized Gravure Printed OSEs to Ambient Light

The photostability of the OSEs in question were studied using a GSS 450 Oxygen Analyser™. Samples of the gravure printed sensor materials made in accordance with example 4 to be tested were cut into 2 cm×2 cm squares and placed into a flow cell. The flow cell was then flushed with 100% N₂. Once the gases within the flow cell had equilibrated at 100% N₂ a reading was taken with the GSS 450 Oxygen Analyser™. The signal to reference value was recorded at 0% O2.

The samples were then removed from the flow cell and exposed to the ambient light source in order to investigate the effect of light on the photodegradation of the dye. Again, the power of the ambient light was measured using a Solar Light Testing—dose control system to be 1 W/m².

The samples were exposed to the ambient light source for varying amounts of time. The effect of the varying doses on the readings was tracked using the flow-cell and GSS 450 Oxygen Analyser. Table 8 below tracks the changes in the signal to reference values.

TABLE 8
Changes in signal to reference values for
a photo-stabilized gravure printed sensor
on exposure to constant light at 1 W/m2.

| Time of | Change in |
|---|---|
| exposure to | Signal to |
| the ambient | reference |
| light/min | values (a.u.) |
| 0 | — |
| 10 | 0 |
| 20 | 0 |
| 30 | 0 |
| 40 | −0.1 |
| 50 | −0.2 |
| 60 | −0.2 |
| 120 | −0.3 |
| 180 | −0.5 |
| 240 | −0.6 |
| 300 | −0.8 |
| 360 | −0.9 |
| 420 | −1 |
| 480 | −1.2 |
| 540 | −1.3 |
| 600 | −1.3 |

Table 8 shows recorded changes in the signal to reference values recorded for the gravure printed OSEs with photostabilizer due to varying exposure to constant ambient light. As with the results in Table 6, the samples exhibited photodegradation features. However, the rate of degradation is much slower in this instance, most notably at longer exposure times, where the rate of photodegradation was approximately 3 times slower than in case of gravure ink based OSE without photostabilizer.

### Experiment H) Sensitivity of Photo-Stabilised Gravure Printed OSEs to an Accelerated Aging Light Source

The same methodology and same exposure times were used as in Experiment G, except the light source was an accelerated aging light source (33 W/m²; measured by Solar Light Testing—dose control system). The accelerated aging light source was used to simulate accelerated photobleaching conditions.

TABLE 9
Changes in signal to reference values for
a photo-stabilized gravure printed sensor
on exposure to constant light at 33 W/m2.

| Time of | Change in |
|---|---|
| exposure to | Signal to |
| the strong light | reference |
| source/min | values (a.u.) |
| 0 | — |
| 10 | −0.4 |
| 20 | −0.8 |
| 30 | −1.1 |
| 40 | −1.5 |
| 50 | −1.8 |
| 60 | −2.1 |
| 120 | −3.1 |
| 180 | −3.9 |
| 240 | −4.6 |
| 300 | −5.2 |
| 360 | −5.7 |
| 420 | −6 |
| 480 | −6.5 |
| 540 | −6.7 |
| 600 | −7.1 |

Table 9 shows recorded changes in the signal to reference values recorded for the OSEs containing photostabilizer due to varying exposure to an accelerated aging light source at 33 W/m². As with the results in Table 7, the samples showed photodegradation features. However, the rate of degradation is much slower in this instance compared to Table 7, most notably at longer exposure times, where the rate of photodegradation was approximately 2 times slower than for the non photo-stabilised gravure printed OSE.

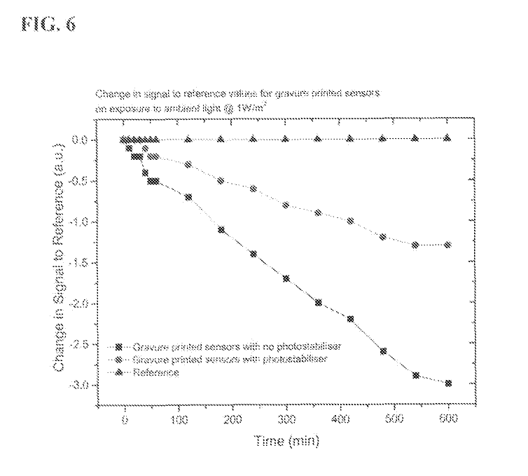

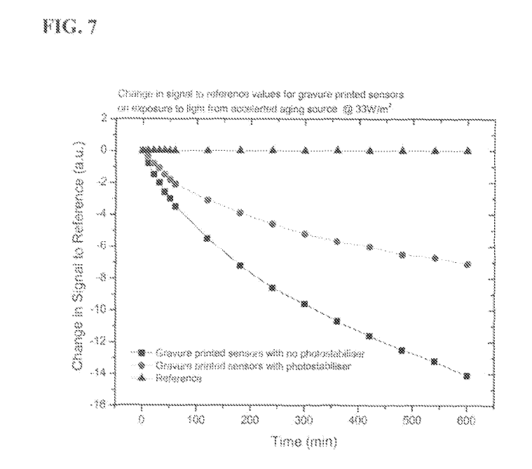

FIG. 6 (exposure of gravure printed OSEs to constant ambient light) and FIG. 7 (exposure of gravure printed OSEs to an accelerated aging light source) compare changes in the signal to reference values recorded for a gravure printed OSE stored in the dark, one with photostabilizer one with photostabilizer. These results point to the effectiveness of adding photostabilizers to the oxygen sensitive inks and coatings in order to improve the long term photostability of the finished OSE. This experiment highlights a 3-fold decrease in the reduction of signal over time for the OSE containing photostabilizer versus the non photo-stabilised OSE under constant ambient light and a 2-fold decrease in the loss of signal of the photostabilized OSE versus the non-photostabilized OSE on exposure to light from the accelerated aging light source.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. An oxygen sensitive ink or coating with enhanced photostability, comprising an oxygen sensitive indicator, a photostabilizer, an oxygen permeable binder and a solvent mixture.

2. The oxygen sensitive ink or coating of claim 1, wherein the oxygen sensitive indicator is selected from, but not limited to [Ru(L1)(L2)(L3)]²⁺, wherein Ru represents the central ruthenium ion, L1, L2 and L3 represent the bidentate ligands diphenylphenanthroline, phenanthroline or bipyridine ligands or optionally substituted variations of same with representative counter ions selected from (PF6)-, Cl—, BF4-, Br— and (Cl04)-, platinum or palladium based metallo-porphyrin.

3. The oxygen sensitive ink or coating of claim 1, wherein the photostabilizer is selected from, but not limited to CIBA TINUVIN 5236, TINUVIN 292, TINUVIN 123 and TINUVIN 272, TINUVIN 477W, DABCO and ascorbic acid.

4. The oxygen sensitive ink or coating of claim 1, wherein the oxygen permeable binder of claim 1, is selected from but not limited to the cellulosic resins family.

5. The oxygen sensitive ink or coating of claim 1, wherein the solvent mixture is either alcohol:ester or alcohol:ketone, or any other combinations thereof.

6. Oxygen sensitive elements made from the oxygen sensitive ink or coating from claim 1 manufactured by printing on a continuous flexible or rigid substrate, wherein the printing method includes but is not limited to ink-jet, gravure, flexographic, pad printing, pin printing.

7. Oxygen sensitive elements made from the oxygen sensitive coating from claim 1 manufactured by coating a continuous flexible or rigid substrate, wherein the coating method includes but is not limited to knife coating, air coating, roll coating, rod coating, gravure coating.

8. The flexible and rigid substrates of claim 6 and claim 7 include, but are not limited to PET, PP, PE, PC, PMMA, glass, metal sheets, cellulose acetate, polyamide, paper and metallised plastic film.
